(19) United States
(12) Patent Application Publication
(10) Pub. No.: US 2018/0330274 A1
(43) Pub. Date: Nov. 15, 2018

(54) IMPORTING SKILLS TO A PERSONAL ASSISTANT SERVICE

(71) Applicant: Microsoft Technology Licensing, LLC, Redmond, WA (US)

(72) Inventors: Dorrene Brown, Redmond, WA (US); Hovhannes Tananyan, Seattle, WA (US); Mengjiao Zhou, Redmond, WA (US); David Brett, Seattle, WA (US)

(21) Appl. No.: 15/620,268

(22) Filed: Jun. 12, 2017

Related U.S. Application Data
(60) Provisional application No. 62/503,500, filed on May 9, 2017.

(51) Int. Cl. G06N 99/00; H04L 12/24; H04L 29/08; G06F 9/44

(52) U.S. Cl. CPC G06N 99/005; H04L 41/0233; H04L 67/02; G06F 8/315; H04L 67/146

(57) ABSTRACT

Techniques for importing skills from a first personal assistant service to a second personal assistant service are described. A machine accesses a skill programmed for the first personal assistant service from a first data file in a first format. The machine determines, based on the first data file, one or more intents used by the skill, each of the one or more intents specifying an action for fulfilling a natural language request of an end-user and including slot(s). The machine determines, based on the first data file, slot types for each of the slot(s) of each of the one or more intents, the slot types specifying sets of potential values for the slot(s), the slot(s) being arguments provided to the one or more intents. The machine stores the one or more intents and the slot types of the skill in a second format for the second personal assistant service.

### PRIORITY CLAIM

This application claims priority to U.S. Provisional Patent Application No. 62/503,500, filed on May 9, 2017, and titled “IMPORTING SKILLS TO A PERSONAL ASSISTANT SERVICE,” the entire disclosure of which is incorporated herein by reference.

### BACKGROUND

Developers develop skills for a personal assistant service. The personal assistant service uses those skills to assist users with various tasks.

### BRIEF DESCRIPTION OF THE DRAWINGS

Some embodiments of the technology are illustrated, by way of example and not limitation, in the figures of the accompanying drawings.

FIGS. 1A-1B illustrates example data flow diagrams for skills in personal assistant services.

FIG. 2 is a flow chart illustrating an example method for importing a skill to a personal assistant service.

FIGS. 3A-3J illustrate example user interfaces of the subject technology.

FIG. 4 is a flow chart illustrating an example method for importing a skill to a personal assistant service.

FIG. 5 is a block diagram illustrating components of a machine able to read instructions from a machine-readable medium and perform any of the methodologies discussed herein, in accordance with some embodiments.

### SUMMARY

The present disclosure generally relates to machines configured for a personal assistant service, including computerized variants of such special-purpose machines and improvements to such variants, and to the technologies by which such special-purpose machines become improved compared to other special-purpose machines that provide technology for personal assistant services. In particular, the present disclosure addresses systems and methods for integrating skills and like operational features into personal assistant services.

### DETAILED DESCRIPTION

The present disclosure describes, among other things, methods, systems, and computer program products that individually provide various functionality. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

As noted above, developers develop skills for a personal assistant service. The personal assistant service uses those skills to assist users with various tasks. An improved developer interface for providing or importing skills to the personal assistant service may be desirable.

A personal assistant service may include a variety of voice, text, or other communication interfaces, and operate to collect a variety of location and context information of a user, for personal customization of information and actions. Examples of personal assistant services may include MICROSOFT® Cortana, AMAZON® Alexa, GOOGLE® Assistant, APPLE® Sid, SAMSUNG® Bixby, among others, but it will be understood that the techniques discussed herein are not limited to any particular implementation of a personal assistant platform. Further, while the terminology used herein may relate to specific programming techniques and interfaces provided by the MICROSOFT® Cortana personal assistant service, it will be understood that similar programming techniques and interfaces might be incorporated by other services and companies (including third party companies that integrate or customize versions of the personal assistant service).

Personal assistant services may use skills or similar capabilities functions to complete tasks and perform certain actions with the personal assistant service. A simple example of a skill might include a restaurant interaction skill, allowing a user to issue a command, such as “Reserve me a table at Mario's Italian Restaurant”. In an example, a “third party” skill refers to a skill that is imported or integrated into the personal assistant service from another source, such as another developer, service (although a third party, skill may include skills directly developed for the personal assistant service by the same developer). As a further example, a third party skill might leverage a different bot and external data source on behalf of another entity (e.g., an external bot hosted by a restaurant reservation service) in order to accomplish the skill action within the personal assistant service.

In some cases, a developer adds new capabilities to a first personal assistant service by creating custom skills. In creating a custom skill, the developer implements the logic for the skill, and defines the voice interface through which end-users interact with the skill. To define the voice interface, the developer maps the end-user's spoken input to the intents the cloud-based service can handle.

A skill may be characterized by intents, sample utterances, and custom slot types. An intent represents an action that fulfills an end-user's spoken request. Intents can optionally have arguments called slots. In some cases, intents are specified in a JSON (JavaScript Object Notation) structure called the intent schema (or intent model). A sample utterance may include a set of likely spoken phrases mapped to the intents. The sample utterances of an intent may include as many representative phrases as possible. Custom slot types may include a representative list of possible values for a slot. Custom slot types are used for lists of items that are not covered by one of the built-in slot types of the first personal assistant service.

In some cases, a first entity (e.g., a business, service provider, etc.) may provide and operate first personal assistant service. A second entity (e.g., another business, service provider, etc.) may provide and operate a second personal assistant service. The second entity may desire to allow developers to easily import skills, which were developed for the first personal assistant service, into the second personal assistant service. Ideally, the importing of the skills would be automated and would require minimal investment from the developers.

Some aspects of the subject technology provide a step-by-step walkthrough to import skills from the first personal assistant service into the second personal assistant service. Each of at least a portion of the skills may include a set of assets, an intent JSON, and a series of sample utterances that trains the speech data.

Some of the problems solved by some aspects of the subject technology include: identifying conceptual gaps between skills in the first personal assistant service and skills in the second personal assistant service; ensuring feature parity between skills in the first personal assistant service and skills in the second personal assistant service; migrating skills between the first personal assistant service and the second personal assistant service; and examining messaging strategies for the skills.

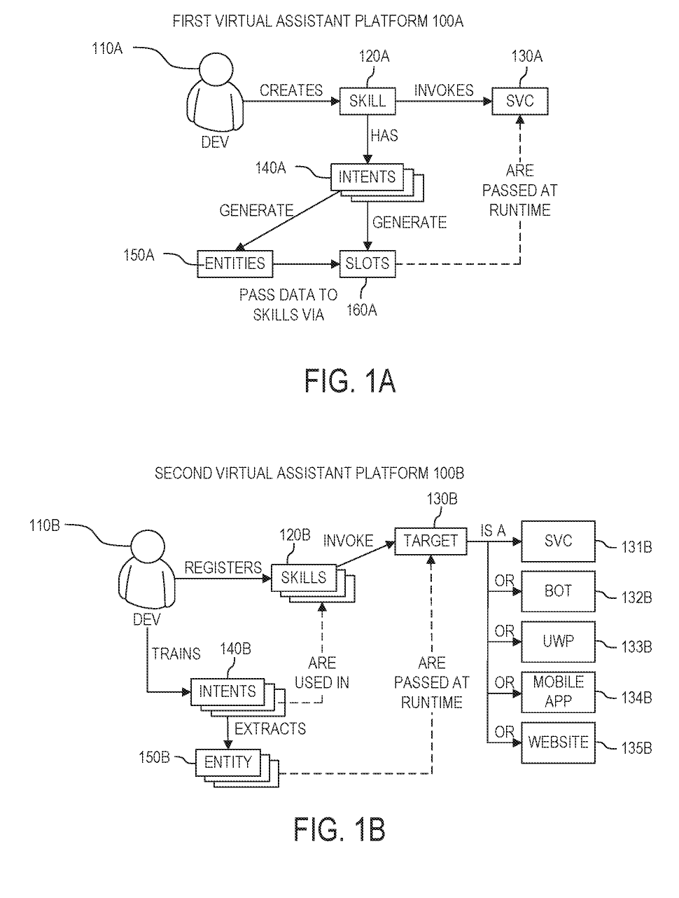

FIGS. 1A-1B illustrates example data flow diagrams for skills in personal assistant services.

As shown in FIG. 1A, in the first personal assistant service 100A, a developer (DEV) 110A creates a skill 120A. The skill 120A has intents 140A. The intents 140A generate entities 150A and slots 160A. The slots 160A are arguments provided to the intents 140A. The entities 150A pass data to skills 120A via slots 160A. The skill 120A invokes a service (SVC) 130A. Slots 160A are passed at runtime to the service 130A.

As shown in FIG. 1B, in the second personal assistant service 100B, a developer (DEV) 110B registers skills 120B which invoke a target 130B. The target 130B may be one or more of a service (SVC) 131B, a bot 132B, a universal windows platform (UWP) application 133B, a mobile application (app) 134B, and/or a website 135B. The developer trains intents 140B which are used in the skills 120B by training the machine to access data and perform operations responsive to utterance(s) by user(s) which are determined to correspond to the intents. The intents 140B extract entities 150B, which are passed at runtime to the target 130B. One issue in the second personal assistant service 100B of FIG. 1B is the mismatch between intent 140B and skill 120B associations.

Some solutions include associating one Language Understanding Intelligent Service (LUIS) per skill. Each skill may have its own LUIS application. The import flow may be streamlined according to the concept of the first personal assistant service in FIG. 1A. Concepts (e.g., conceptual information, language models, and the like) not related to the first personal assistant service may be removed. At runtime, LUIS entities may be called slots in the skills Application Programming Interface (API) JSON. Skills related to the first personal assistant service may be their own class of skills.

In accordance with the LUIS format, entities are key data in an application's domain. An entity represents a class including a collection of similar objects (places, things, people, events or concepts). Entities describe information relevant to the intent, and are sometimes useful for an application to perform a task. For example, a News Search application may include entities such as “topic”, “source”, “keyword” and “publishing date”, which are key data to search for news. In a travel booking application, the “location”, “date”, “airline”, “travel class” and “tickets” are key information for flight booking (e.g., relevant to the “book-flight” intent), that can be added as entities. Entities may include prebuilt entities which are provided by the second personal assistant service (e.g., commonly used entities, such as the days of the week or the months of the year) or user-defined entities (e.g., a list of airports in the United States or a list of airlines).

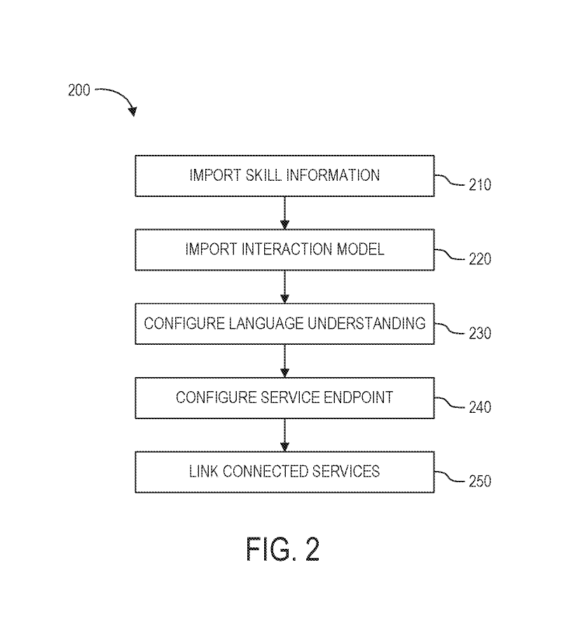

FIG. 2 is a flow chart illustrating an example method 200 for importing a skill to a personal assistant service. In accordance with some aspects of the subject technology, the second personal assistant service implements the method 200. In implementing the method 200, the second personal assistant service: imports skill information from the first personal assistant service at operation 210; imports an interaction model at operation 220; configures language understanding at operation 230; configures a service endpoint at operation 240; and links connected service(s) at operation 250.

At operation 210, the developer provides the information the second personal assistant service needs to show the skill(s) to the end users. Examples of imported fields are shown in Table 1.

TABLE 1
Imported Fields.

| Field Name | Input type | Help Text |
|---|---|---|
| Display | String | This is the name of the skill |
| Name | | that will appear in the visual |
| | | interface of the second |
| | | personal assistant service. |
| | | Can be up to 30 characters |
| | | long. |
| Invocation | String | This is the phrase users will |
| Name | | say when invoking a skill. |
| | | This is unique to the skill- |
| | | a server may check to make |
| | | sure. |
| Short | String-200 characters | A short description of the |
| Description | max | skill's functionality, used to |
| | | describe the skill in a |
| | | notebook (i.e., a description |
| | | of the functionalities of the |
| | | second personal assistant |
| | | system). |
| Long | Long string | A longer description of the |
| Description | | skill. Used where skills are |
| | | discoverable (like a store |
| | | associated with the second |
| | | personal assistant system). |
| Website | HTTPS (hypertext | The skill's website. Used |
| | transfer protocol | where the second personal |
| | secure) URI | assistant service needs to |
| | (uniform resource | provide more information |
| | indicator) | about the skill. |
| Privacy | HTTPS URI | A link to the privacy policy |
| Policy | | for the skill. |
| Terms and | HTTPS URI | A link to the terms and |
| Conditions | | conditions users must |
| | | consent to before using the |
| | | skill. |
| Icon | 48 × 48 pixel image | The symbol that visually |
| | file (png, jpg, gif) | indicates the skill in both |
| | | the User Experience (UX) |
| | | and the store of the second |
| | | personal assistant system. |
| Does this | Yes/no radio option | The second personal |
| skill make | | assistant service may |
| authenticated | | manage the end-user's |
| calls? | | QAUTH (open |
| | | authoiization) identity and |
| | | tokens if the skill makes |
| | | authenticated service calls. |
| | | A developer may select |
| | | “yes” to link the connected |
| | | service to this skill. |

At operation 220, the developer imports the intents and entities that are used with the skill in the first personal assistant service. This information is used at operation 230 to create the intent schema (or intent model) used by the skill in the second personal assistant service. An intent schema (or intent model) may be specified in a JSON structure (or other structure) specifying the intent or the action(s), taken by the machine, for fulfilling the end-user's spoken request. Examples of the imported fields are shown in Table 2.

TABLE 2
Imported Fields.

| Field Name | Input type | Help Text |
|---|---|---|
| Intent Schema | JSON | The end-user intent |
| | | schema that the developer |
| | | created when building the |
| | | skill for the first personal |
| | | assistant service. |
| Custom Slot Types | Collection of types and | The slots the developer |
| | values | created and used to pass |
| | | data to the skill in the first |
| | | personal assistant service. |
| Sample Utterances | Text file as string | The sample utterances |
| | | used to create the intents in |
| | | the first personal assistant |
| | | service. These can be used |
| | | as training data for the skill |
| | | in the second personal |
| | | assistant service. |

At operation 230, the second personal assistant service configures the natural language understanding of the second personal assistant service to the imported skill. The natural language understanding platform of the second personal assistant service allows for more flexibility when interacting with skills. Sample utterances and the intent JSON provided at operation 220 are used to train the skill's intent model. The fields shown in Table 3 may be imported

TABLE 3
Imported Fields.

| Field Name | Input type | Help Text |
|---|---|---|
| [Name of | Checkbox or LUIS training | |
| intent] | UX (user experience) | |
| Training | List of utterances (with | These are the sample |
| data | intent removed) | utterances used to train |
| | | the intent model. |

At operation 240, the second personal assistant service configures the service endpoint. The developer adds the HTTPS (Hypertext Transfer Protocol Secure) endpoint that the second personal assistant service calls when invoking the skill. In some cases, the service endpoints for the first personal assistant service and the second personal assistant service may be different. The field shown in Table 4 may be imported.

TABLE 4
Imported Fields.

| Field Name | Input type | Help Text |
|---|---|---|
| Service Endpoint | HTTPS URI | The HTTPs URI that the |
| | | second personal assistant |
| | | service calls in order to |
| | | enable skill functionality. |

At operation 250, the second personal assistant service links connected services. If the imported skill requires authentication, connected account(s) are linked so that the second personal assistant service cam make authenticated service calls. The fields shown in Table 5 may be imported. In some cases, a name icon, a privacy policy, and/or a connected account may also be imported.

TABLE 5
Imported Fields.

| Field Name | Input type | Help Text |
|---|---|---|
| Client authentication | Dropdown | The mechanism by which |
| scheme | HTTP Basic | the second personal |
| | Token in request | assistant service passes a |
| | body | bearer token. |
| Client ID for third | String | The client identifier that |
| party services | | the second personal |
| | | assistant service uses as |
| | | part of an authorization |
| | | (e.g., Open Authorization |
| | | (OAUTH)) flow. |
| Client secret/ | String | The client secret the |
| password | | second personal assistant |
| | | service uses as part of the |
| | | authorization flow. |
| Authentication URL | HTTPS URI | The LTRI the second |
| | | personal assistant service |
| | | calls to authorize the user. |
| Token URL | HTTPS URI | The URI the second |
| | | personal assistant service |
| | | calls to fetch tokens. |
| List of scopes | Newline-separated | A list of scopes the second |
| | strings | personal assistant service |
| | | uses as part of the skill |
| | | execution flow. The |
| | | developer enters one scope |
| | | per line. |
| Token Options | Radio Button | How the second personal |
| | GET | assistant service is to |
| | POST | obtain tokens. |

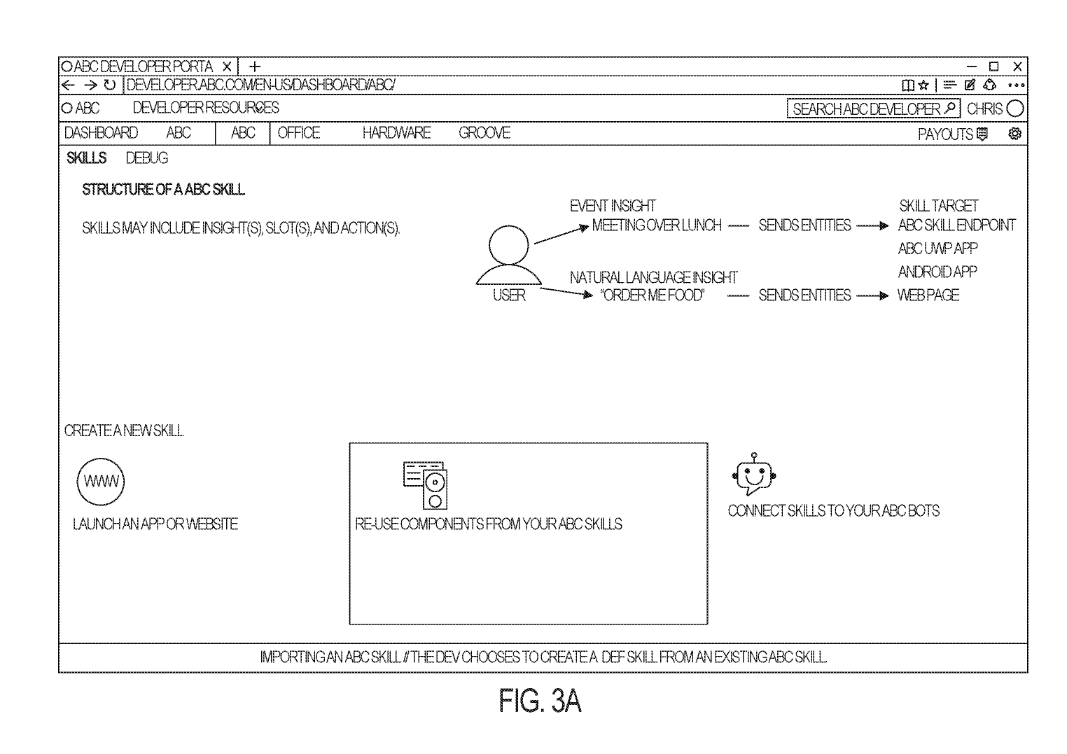

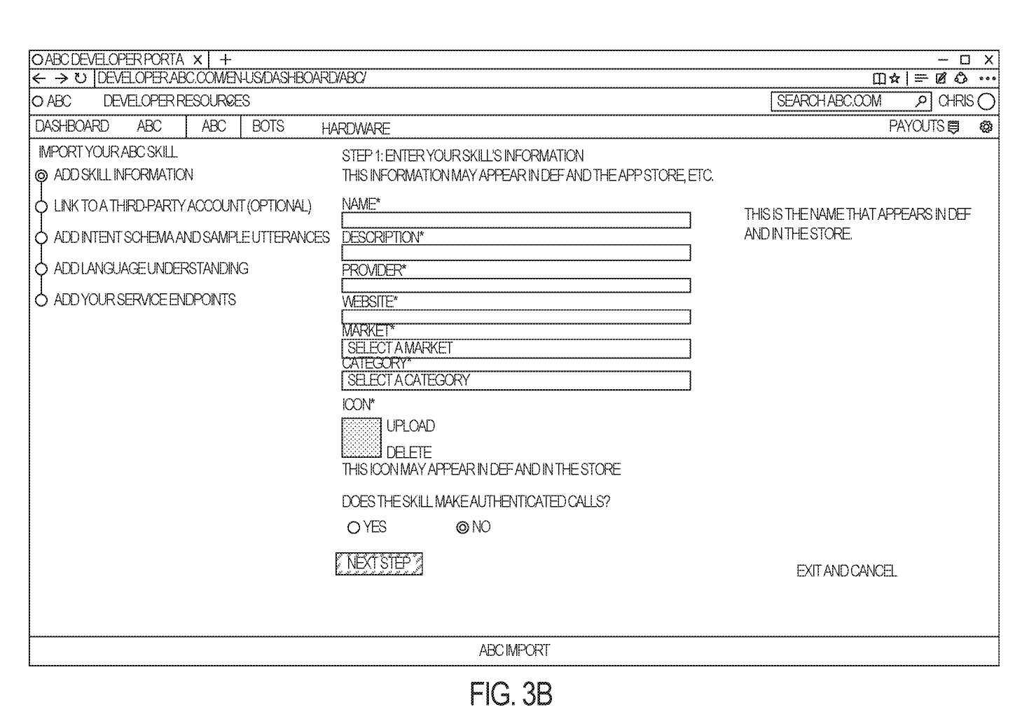

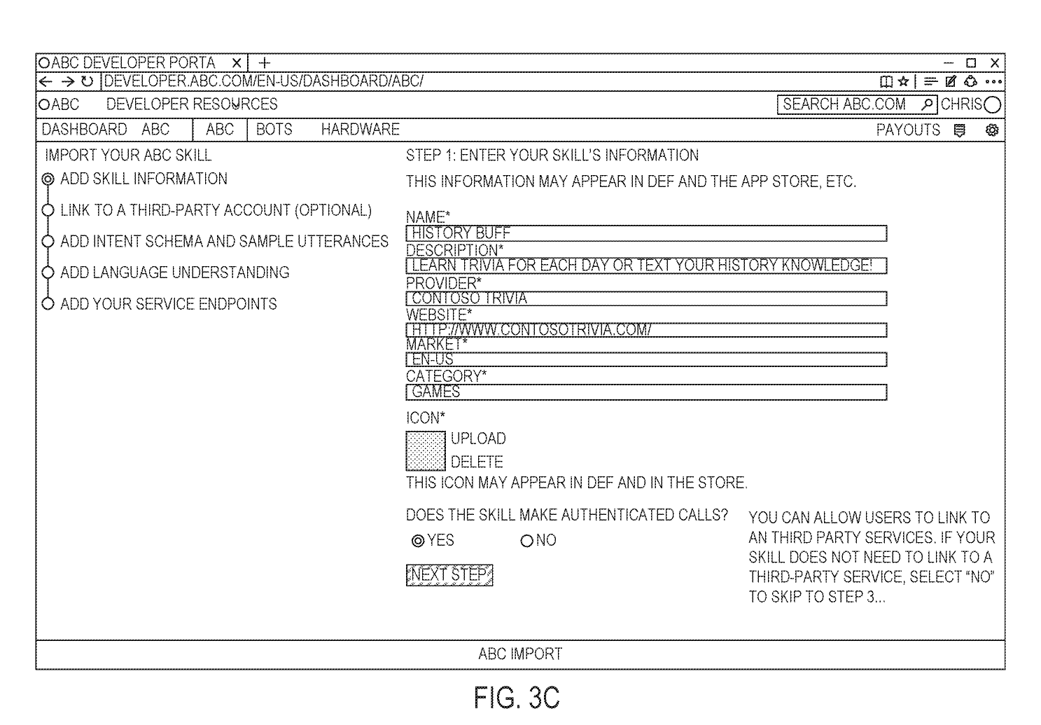

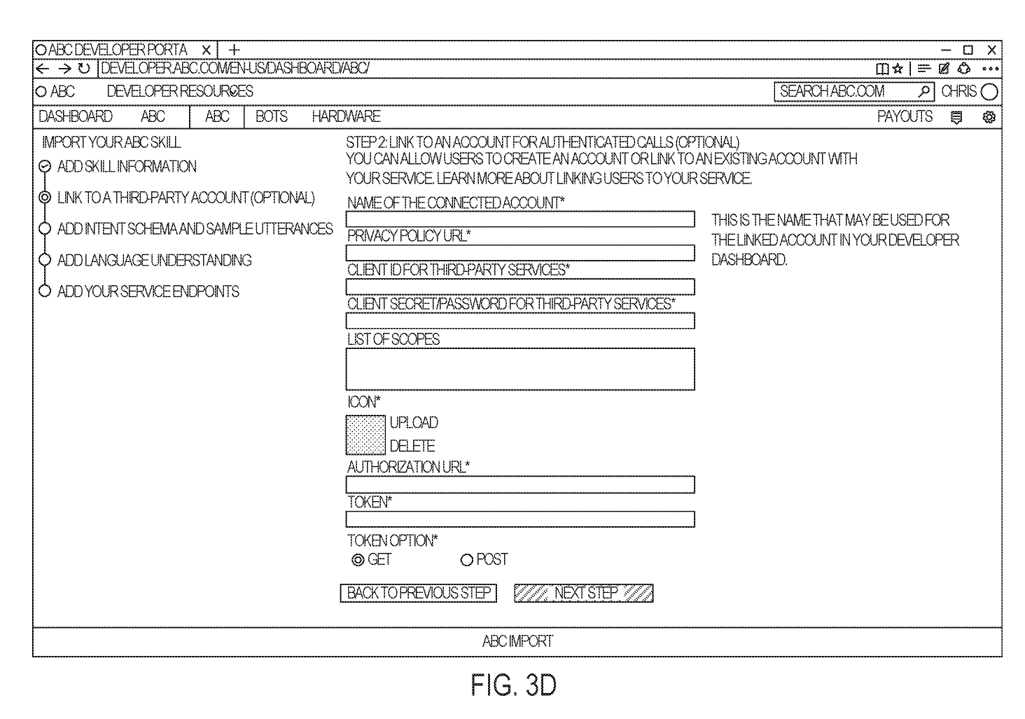

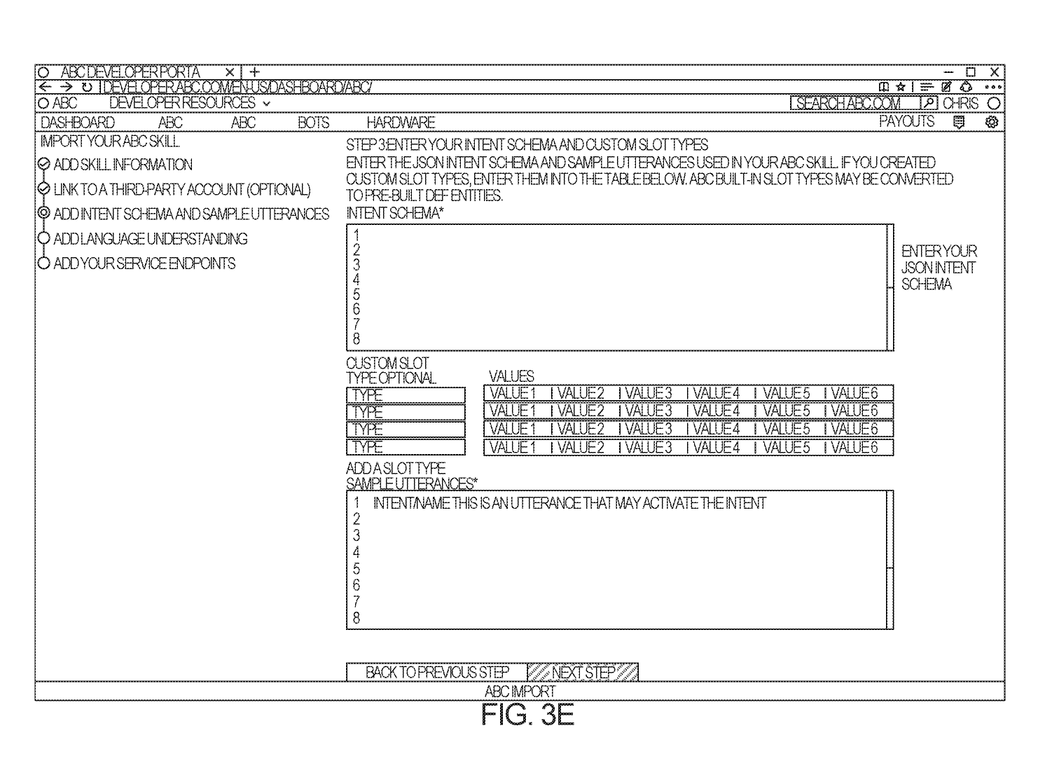

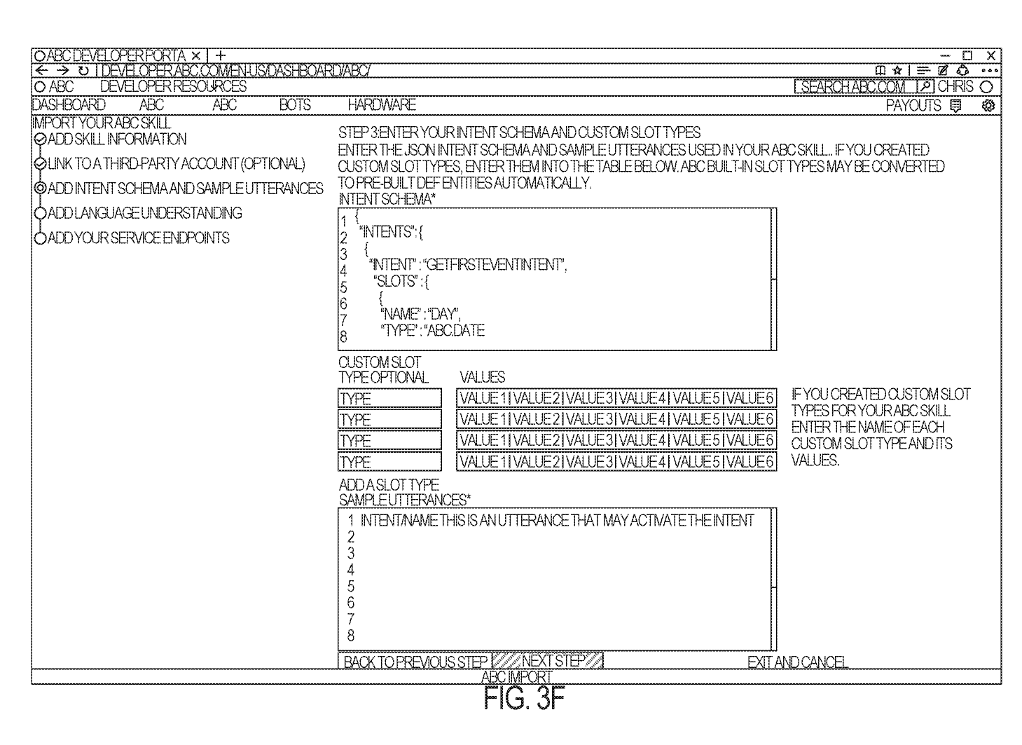

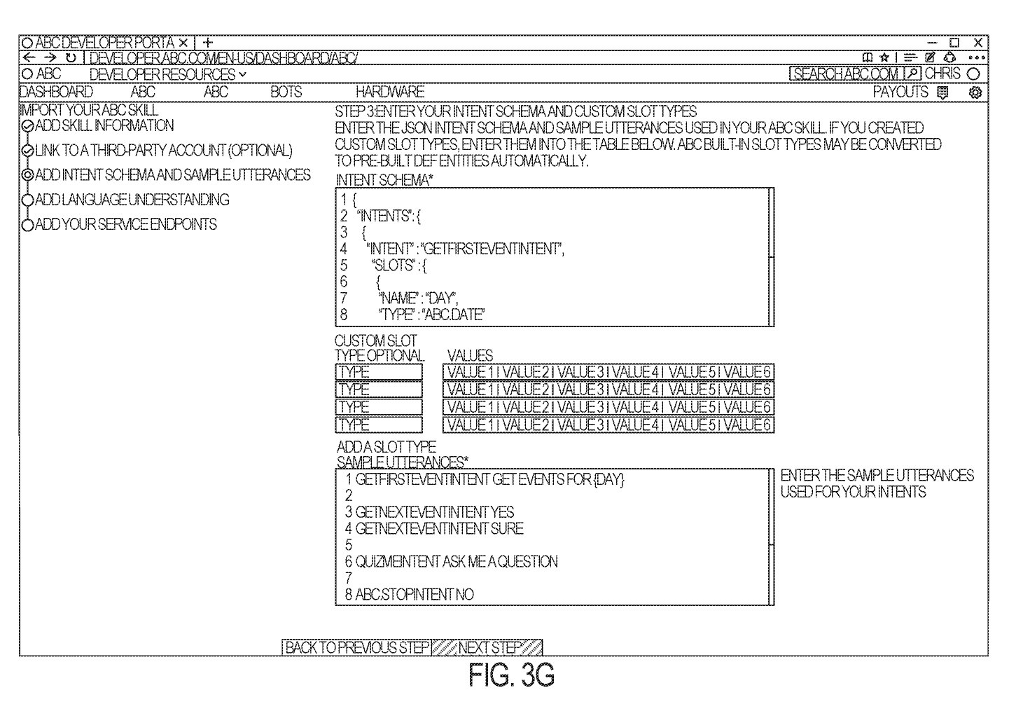

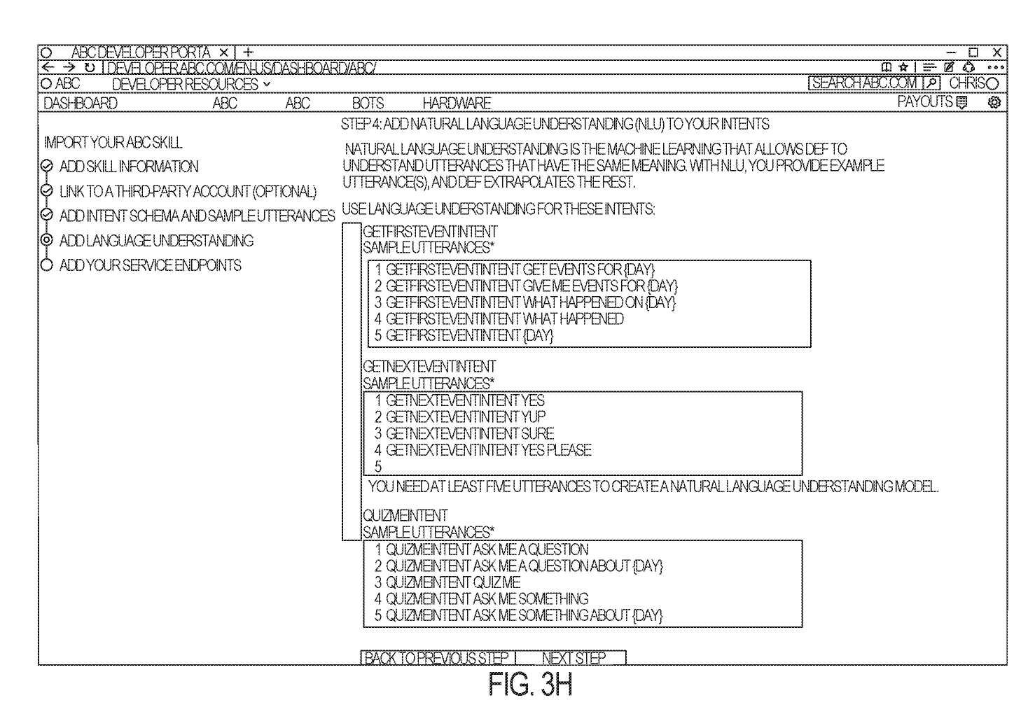

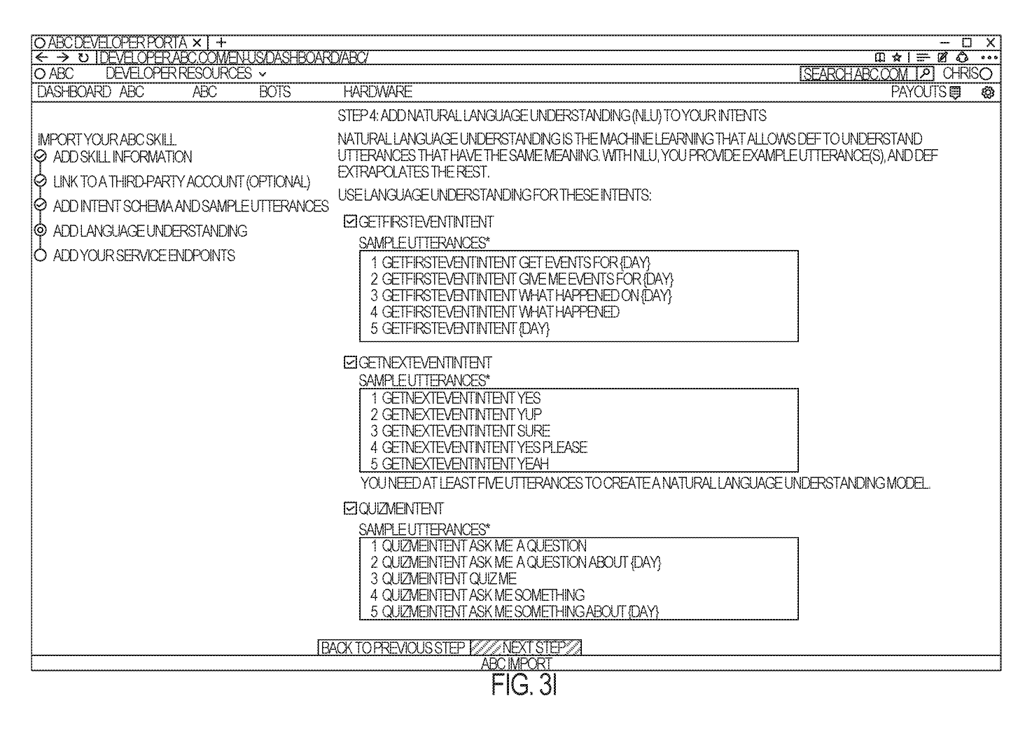

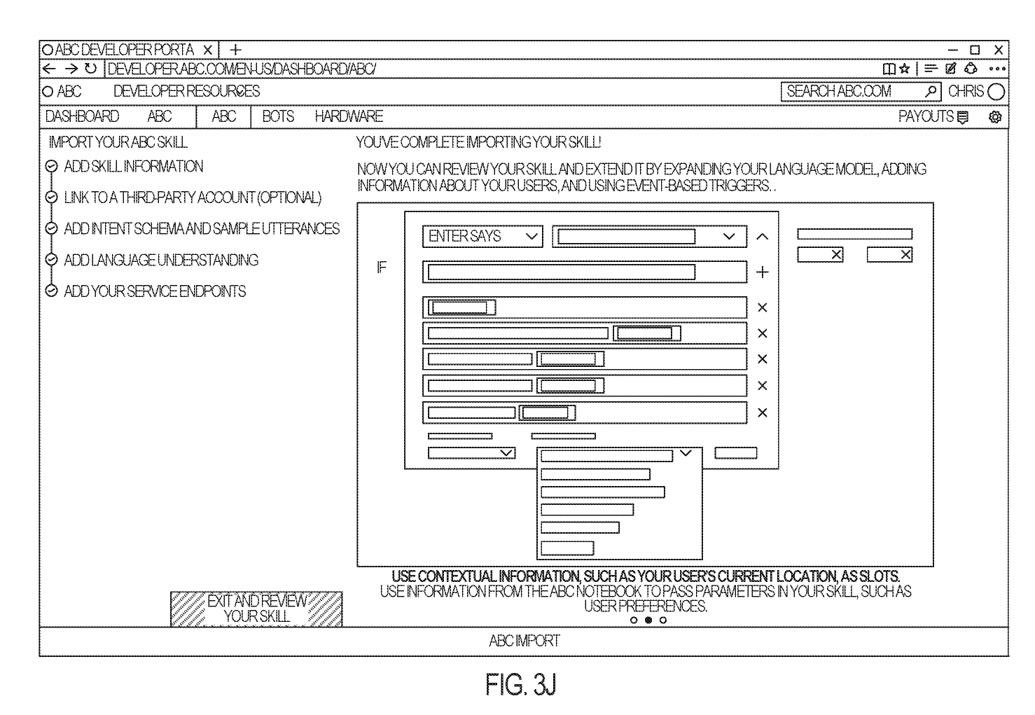

FIGS. 3A-3J illustrate example user interfaces of the subject technology. The user interfaces may be used to adding skill(s) and information related to the skill(s) to the second personal assistant service. FIG. 3A illustrates an example structure of a skill. A skill may correspond to: if X happens, then the machine does Y. A skill may include insight(s), slot(s), and action(s). An insight is a predefined condition associated with a user. A skill may have at least one insight associated with it, and all associated insights may be true for the skill to be triggered. An insight may be a predefined condition associated with a user. FIG. 3B illustrates a first example interface for entering information about a skill. FIG. 3C illustrates a second example interface for entering information about a skill. FIG. 3D illustrates an example interface for linking an account for authenticated calls. FIG. 3E illustrates a first example interface for entering an intent schema and custom slot types. FIG. 3F illustrates a second example interface for entering an intent schema and custom slot types. FIG. 3G illustrates a third example interface for entering an intent schema and custom slot types. FIG. 3H illustrates a first example interface for adding natural language understanding (NLU) to intents. FIG. 3I illustrates a second example interface for adding NLU to intents. FIG. 3J illustrates an example interface indicating completion of importing a skill.

One example of the use of the screenshots of FIGS. 3A-3J is described below using, as an example, a skill created for a rideshare application. The page of FIG. 3A provides an overview of the technology and the means by which a developer can create or import a skill. In this case, the developer will decide to import a skill. The page of FIG. 3B is for collecting metadata about the skill as well as determining whether the page shown in FIG. 3D is to be used. Example uses of the data collected in FIG. 3B are explained in Table 1. The developer fills in a description of the skill that can be shown to end users. FIG. 3C is used similarly to FIG. 3B, but has a different layout. The page of FIG. 3D allows the developer to configure an OAUTH account. If the rideshare company is an OAUTH provider, this page enables the rideshare company to manage user access to the skill. The page of FIG. 3E allows the developer to create a language model on the second personal assistant service (e.g., a LUIS language model) using the same input that was provided to the first personal assistant service. FIGS. 3F-3G show the same page as FIG. 3E in different stages of completion. FIGS. 3H-3I illustrate an interface for adding additional information to the model provided in FIG. 3E. FIG. 3J shows an interface for an example review feature.

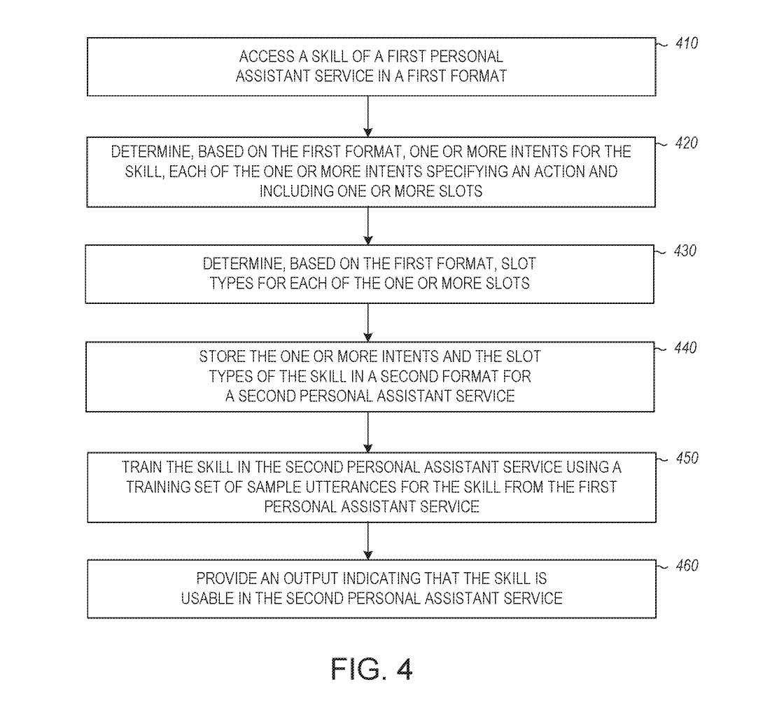

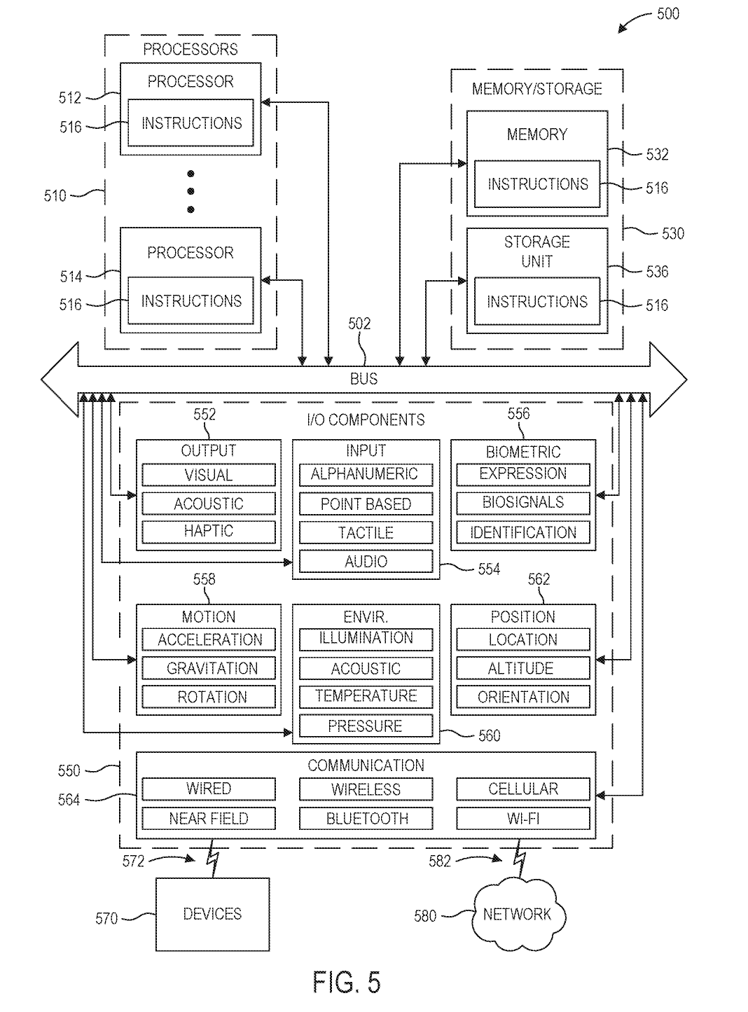

FIG. 4 is a flow chart illustrating an example method 400 for importing a skill to a personal assistant service. The method 400 may be implemented by a computer, such as the machine 500 of FIG. 5. The computer may be a client device or a server.

At operation 410, the computer access a skill of a first personal assistant service (e.g., Amazon Alexa®) in a first format. The skill may be programmed in JSON. For example, a developer might provide a skill that the developer developed for the first virtual assistant service for use in the second virtual assistant service. In some cases, accessing the skill includes importing (e.g., to the second virtual assistance service, described below) multiple fields associated with the skill. The fields may include the fields specified in Tables 1-5, for example, a name, a description, a URI, and authentication information.

At operation 420, the computer determines, based on the first format, one or more intents for the skill. Each of the one or more intents specifies an action for fulfilling a spoken request of an end-user and includes one or more slots. Each of the one or more intents is structured according to an intent schema of the first format.

At operation 430, the computer determines, based on the first format, slot types for each of the one or more slots of each of the one or more intents. The slot types specify a set of potential values for the one or more slots. For example, if the slot represents horoscope signs, the slot types may include: Aries, Taurus, Gemini, Cancer, Leo, Pisces, Virgo, Libra, Scorpio, Sagittarius, Capricorn, and Aquarius. Contextual info may be relevant as it is one of the most likely sources of discontinuity between the first personal assistant service and the second personal assistant service. Different personal assistant services may have differing information about the user and the device, and may have different formats for expressing that information.

At operation 440, the computer stores the one or more intents and the slot types of the skill in a second format for a second personal assistant service (e.g., Microsoft Cortana®). The first format is associated with a first technique for operating on input and the second format is associated with a second technique for operating on input. The second technique is different from the first technique. In some cases, the second personal assistant service processes natural language using LUIS. For example, the slot(s) of the skill (which may be programmed in JSON) may correspond to entities in LUIS. In some examples, the first virtual assistant service is JSON-based and the second personal assistant service is LUIS-based. The skill may be mapped to a single LUIS model.

At operation 450, the computer trains (e.g., using machine learning techniques) the skill in the second personal assistant service using a training set of sample utterances for the skill from the first personal assistant service. Any machine learning technique may be used. In some cases, the sample utterances include a set of likely spoken phrases mapped to intents from among the one or more intents of the skill.

At operation 460, the computer provides an output indicating that the skill is usable in the second personal assistant service. The output may notify the developer that the developer's skill was successfully entered into the second personal assistant service.

### Components and Logic

Certain embodiments are described herein as including logic or a number of components or mechanisms. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

In some embodiments, a hardware component may be implemented mechanically, electronically, or any suitable combination thereof. For example, a hardware component may include dedicated circuitry or logic that is permanently configured to perform certain operations. For example, a hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations.

Accordingly, the phrase “hardware component” should be understood to encompass a tangible record, be that a record that is physically constructed, permanently configured (e.g., hardwired), or temporarily configured (e.g., programmed) to operate in a certain manner or to perform certain operations described herein. As used herein, “hardware-implemented component” refers to a hardware component. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of tune.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors.

Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

Some aspects of the subject technology involve collecting personal information about users. It should be noted that the personal information about a user is collected after receiving affirmative consent from the users for the collection and storage of such information. Persistent reminders (e.g., email messages or information displays within an application) are provided to the user to notify the user that his/her information is being collected and stored. The persistent reminders may be provided whenever the user accesses an application or once every threshold time period (e.g., an email message every week). For instance, an arrow symbol may be displayed to the user on his/her mobile device to notify the user that his/her global positioning system (GPS) location is being tracked. Personal information is stored in a secure manner to ensure that no unauthorized access to the information takes place. For example, medical and health related information may be stored in a Health Insurance Portability and Accountability Act (HIPAA) compliant manner.

### Example Machine and Software Architecture

The components, methods, applications, and so forth described in conjunction with FIGS. 1-4 are implemented in some embodiments in the context of a machine and an associated software architecture. The sections below describe representative software architecture(s) and machine (e.g., hardware) architecture(s) that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things,” while yet another combination produces a server computer for use within a cloud computing architecture. Not all combinations of such software and hardware architectures are presented here, as those of skill in the art can readily understand how to implement the disclosed subject matter in different contexts from the disclosure contained herein.

FIG. 5 is a block diagram illustrating components of a machine 500, according to some example embodiments, able to read instructions from a machine-readable medium (e.g., a machine-readable storage medium) and perform any one or more of the methodologies discussed herein. Specifically, FIG. 5 shows a diagrammatic representation of the machine 500 in the example form of a computer system, within which instructions 516 (e.g., software, a program, an application, an applet, an app, or other executable code) for causing the machine 500 to perform any one or more of the methodologies discussed herein may be executed. The instructions 516 transform the general, non-programmed machine into a particular machine programmed to carry out the described and illustrated functions in the manner described. In alternative embodiments, the machine 500 operates as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, PC, a tablet computer, a laptop computer, a netbook, a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 516, sequentially or otherwise, that specify actions to be taken by the machine 500. Further, while only a single machine 500 is illustrated, the term “machine” shall also be taken to include a collection of machines 500 that individually or jointly execute the instructions 516 to perform any one or more of the methodologies discussed herein.

The machine 500 may include processors 510, memory/storage 530, and I/O components 550, which may be configured to communicate with each other such as via a bus 502. In an example embodiment, the processors 510 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 512 and a processor 514 that may execute the instructions 516. The term “processor” is intended to include multi-core processors that may comprise two or more independent processors (sometimes referred to as “cores”) that may execute instructions contemporaneously. Although FIG. 5 shows multiple processors 510, the machine 500 may include a single processor with a single core, a single processor with multiple cores (e.g., a multi-core processor), multiple processors with a single core, multiple processors with multiples cores, or any combination thereof.

The memory/storage 530 may include a memory 532, such as a main memory, or other memory storage, and a storage unit 536, both accessible to the processors 510 such as via the bus 502. The storage unit 536 and memory 532 store the instructions 516 embodying any one or more of the methodologies or functions described herein. The instructions 516 may also reside, completely or partially, within the memory 532, within the storage unit 536, within at least one of the processors 510 (e.g., within the processor's cache memory), or any suitable combination thereof, during execution thereof by the machine 500. Accordingly, the memory 532, the storage unit 536, and the memory of the processors 510 are examples of machine-readable media.

As used herein, “machine-readable medium” means a device able to store instructions (e.g., instructions 516) and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 516. The term “machine-readable medium” shall also be taken to include any medium, or combination of multiple media, that is capable of storing instructions (e.g., instructions 516) for execution by a machine (e.g., machine 500), such that the instructions, when executed by one or more processors of the machine (e.g., processors 510), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 550 may include a wide variety of components to receive input, provide output, produce output, transmit information, exchange information, capture measurements, and so on. The specific I/O components 550 that are included in a particular machine will depend on the type of machine. For example, portable machines such as mobile phones will likely include a touch input device or other such input mechanisms, while a headless server machine will likely not include such a touch input device. It will be appreciated that the I/O components 550 may include many other components that are not shown in FIG. 5. The I/O components 550 are grouped according to functionality merely for simplifying the following discussion and the grouping is in no way limiting. In various example embodiments, the I/O components 550 may include output components 552 and input components 554. The output components 552 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 554 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 550 may include biometric components 556, motion components 558, environmental components 560, or position components 562, among a wide array of other components. For example, the biometric components 556 may include components to detect expressions (e.g., hand expressions, facial expressions, vocal expressions, body gestures, or eye tracking), measure biosignals (e.g., blood pressure, heart rate, body temperature, perspiration, or brain waves), measure exercise-related metrics (e.g., distance moved, speed of movement, or time spent exercising) identify a person (e.g., voice identification, retinal identification, facial identification, fingerprint identification, or electroencephalogram based identification), and the like. The motion components 558 may include acceleration sensor components (e.g., accelerometer), gravitation sensor components, rotation sensor components (e.g., gyroscope), and so forth. The environmental components 560 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 562 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 550 may include communication components 564 operable to couple the machine 500 to a network 580 or devices 570 via a coupling 582 and a coupling 572, respectively. For example, the communication components 564 may include a network interface component or other suitable device to interface with the network 580. In further examples, the communication components 564 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 570 may be another machine or any of a wide variety of peripheral devices (e.g., a peripheral device coupled via a USB).

Moreover, the communication components 564 may detect identifiers or include components operable to detect identifiers. For example, the communication components 564 may include Radio Frequency Identification (RFID) tag reader components, NFC smart tag detection components, optical reader components, or acoustic detection components (e.g., microphones to identify tagged audio signals). In addition, a variety of information may be derived via the communication components 564, such as location via Internet Protocol (IP) geolocation, location via Wi-Fi® signal triangulation, location via detecting an NFC beacon signal that may indicate a particular location, and so forth.

In various example embodiments, one or more portions of the network 580 may be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 580 or a portion of the network 580 may include a wireless or cellular network and the coupling 582 may be a Code Division Multiple Access (CDMA) connection, a Global System for Mobile communications (GSM) connection, or another type of cellular or wireless coupling. In this example, the coupling 582 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 5G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 516 may be transmitted or received over the network 580 using a transmission medium via a network interface device (e.g., a network interface component included in the communication components 564) and utilizing any one of a number of well-known transfer protocols (e.g., HTTP). Similarly, the instructions 516 may be transmitted or received using a transmission medium via the coupling 572 (e.g., a peer-to-peer coupling) to the devices 570. The term “transmission medium” shall be taken to include any intangible medium that is capable of storing, encoding, or carrying the instructions 516 for execution by the machine 500, and includes digital or analog communications signals or other intangible media to facilitate communication of such software.

What is claimed is:

1. A system comprising:
one or more processors; and
a memory comprising instructions which, when executed by the one or more processors, cause the one or more processors to perform operations comprising:
accessing a skill programmed for a first personal assistant service from a first data file in a first format;
determining, based on the first data file in the first format, one or more intents used by the skill, each of the one or more intents specifying an action for fulfilling a natural language request of an end-user and including one or more slots;
determining, based on the first data file in the first format, slot types for each of the one or more slots of each of the one or more intents, the slot types specifying sets of potential values for the one or more slots, the one or more slots being arguments provided to the one or more intents;
storing the one or more intents and the slot types of the skill in a second format for a second personal assistant service; and
providing an output indicating that the skill is usable in the second personal assistant service.

2. The system of claim 1, the operations further comprising:
training the skill in the second personal assistant service using a training set of sample utterances for the skill, the training set having been utilized with the first personal assistant service.

3. The system of claim 1, wherein the first format is associated with a first technique for operating on input and the second format is associated with a second technique for operating on input.

4. The system of claim 1, wherein the skill is programmed in JSON (JavaScript Object Notation), and wherein the second personal assistant service processes natural language using LUIS (Language Understanding Intelligent Service).

5. The system of claim 4, wherein the skill is mapped to a single LUIS model.

6. The system of claim 1, wherein each of the one or more intents is structured according to an intent schema of the first format.

7. The system of claim 1, wherein the sample utterances comprise a set of likely natural language phrases mapped to intents from among the one or more intents of the skill.

8. The system of claim 1, wherein accessing the skill comprises importing a plurality of fields associated with the skill.

9. The system of claim 8, wherein the plurality of fields comprise one or more of a name, a description, a URI (uniform resource indicator), and authentication information.

10. A non-transitory machine-readable medium comprising instructions which, when executed by a machine, cause the machine to perform operations comprising:
accessing a skill programmed for a first personal assistant service from a first data file in a first format;
determining, based on the first data file in the first format, one or more intents used by the skill, each of the one or more intents specifying an action for fulfilling a natural language request of an end-user and including one or more slots;
determining, based on the first data file in the first format, slot types for each of the one or more slots of each of the one or more intents, the slot types specifying sets of potential values for the one or more slots, the one or more slots being arguments provided to the one or more intents;
storing the one or more intents and the slot types of the skill in a second format for a second personal assistant service; and
providing an output indicating that the skill is usable in the second personal assistant service.

11. The machine-readable medium of claim 10, the operations further comprising:
training the skill in the second personal assistant service using a training set of sample utterances for the skill, the training set having been utilized with the first personal assistant service.

12. The machine-readable medium of claim 10, wherein the first format is associated with a first technique for operating on input and the second format is associated with a second technique for operating on input.

13. The machine-readable medium of claim 10, wherein the skill is programmed in JSON (JavaScript Object Notation), and wherein the second personal assistant service processes natural language using LUIS (Language Understanding Intelligent Service).

14. The machine-readable medium of claim 13, wherein the skill is mapped to a single LUIS model.

15. The machine-readable medium of claim 10, wherein each of the one or more intents is structured according to an intent schema of the first format.

16. The machine-readable medium of claim 10, wherein the sample utterances comprise a set of likely natural language phrases mapped to intents from among the one or more intents of the skill.

17. The machine-readable medium of claim 10, wherein accessing the skill comprises importing a plurality of fields associated with the skill.

18. The machine-readable medium of claim 17, wherein the plurality of fields comprise one or more of a name, a description, a URI (uniform resource indicator), and authentication information.

19. A method comprising:
accessing a skill programmed for a first personal assistant service from a first data file in a first format;
determining, based on the first data file in the first format, one or more intents used by the skill, each of the one or more intents specifying an action for fulfilling a natural language request of an end-user and including one or more slots;
determining, based on the first data file in the first format, slot types for each of the one or more slots of each of the one or more intents, the slot types specifying sets of potential values for the one or more slots, the one or more slots being arguments provided to the one or more intents;
storing the one or more intents and the slot types of the skill in a second format for a second personal assistant service; and
providing an output indicating that the skill is usable in the second personal assistant service.

20. The method of claim 19, further comprising:
training the skill in the second personal assistant service using a training set of sample utterances for the skill, the training set having been utilized with the first personal assistant service.
